(19) United States
(12) Patent Application Publication
(10) Pub. No.: US 2007/0057594 A1
(43) Pub. Date: Mar. 15, 2007

(54) Brush for vibration motor

(75) Inventors: Sung-Taek Oh, Suwon-si (KR); Hyun-Seung Ki, Suwon-si (KR); Young-Jun Joo, Suwon-si (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRO-MECHANICS CO. LTD., Suwon-si (KR)

(21) Appl. No.: 11/519,202

(22) Filed: Sep. 12, 2006

(30) Foreign Application Priority Data
Sep. 12, 2005 (KR) 10-2005-0084819

(51) Int. Cl. H02K 7/06; H01R 39/38

(52) U.S. Cl. 310/239; 310/81

(57) ABSTRACT

A brush for a vibration motor is disclosed. A brush in contact with a flat commutator for supplying a current, comprises a plurality of arms in contact with the flat commutator in substantially the same plane, and a support portion, which forms an electrical connection with a current source, for supplying a current to the arms and for securing and supporting the brush, where the support portion comprises a through hole of a designated size configured to allow an inflow of solder. Since the inflow of solder through the through hole secures the brush, whereby the adhesion between the brush and the flexible board may be enhanced.

### CROSS-REFERENCE TO RELATED APPLICATIONS

This application claims the benefit of Korean Patent Application No. 2005-0084819 filed with the Korean Intellectual Property Office on Sep. 12, 2005, the disclosure of which is incorporated herein by reference in its entirety.

### BACKGROUND

1. Technical Field

The present invention relates to a brush for a vibration motor.

2. Description of the Related Art

The vibration motor having an eccentric rotor is currently widely used in mobile phones and PDAs, etc., as a means of creating vibration upon receipt of incoming calls. As telecommunication devices decrease in size, the demand for smaller and thinner vibration motors is also increasing. FIG. 1 is a cross-sectional view illustrating the structure of a conventional vibration motor. The conventional vibration motor has a bracket 1 at the bottom. One end of a shaft 9 is inserted and secured to the center of the bracket 1, and the other end of the shaft 9 is secured by a case 8. The case 8 protects the other parts of the vibration motor from external interferences. A flexible board 12 of minute thickness is placed on the top of the bracket 1.

A multi-polar magnet 2 with alternating N, S poles along its circumference is placed on the perimeter of the central flexible board 12, and in the central cavity of the magnet 2, a pair of brushes 3 are positioned at a designated angle with the lower ends attached to the flexible board 12. A bearing 11 is inserted onto a designated position of the shaft 9, and an eccentric rotor 10 is inserted onto the perimeter of the bearing 11. A plurality of flat commutators 7 that are in contact with the brushes 3 are positioned on the bottom of the rotor 10.

FIG. 2 is a perspective view of brushes 3 used in a conventional vibration motor. As illustrated in FIG. 2, a conventional brush 3 consists of arms 15 that are contact with the commutators 7, a slit portion 17 formed between the arms 15, a lead portion 19 extending from the arms 15, and a securing portion 21 extending from the lead portion 19.

One end on each of the arms 15, as illustrated in FIG. 1, is folded into the shape of an arc to contact the commutator 7. The arm 15 maintains contact with the commutator 7 by means of the elasticity of the arm itself and the elasticity of the lead portion 19 and securing portion 21. If the arms 15 are disengaged from contact with the commutator, the vibration motor is unable to function. The securing portion 21, as illustrated in FIG. 1, is secured onto the flexible board 12 by solder, etc. The securing method includes performing soldering, by placing the securing portion on solder cream and applying a hot blast while applying pressure with a jig.

However, since the conventional brush 3 is subject to fatigue loads due to the rotation of the rotor 6, the brush 3 is eventually detached from the flexible board 12. In particular, as the stresses caused by the rotation of the rotor 6 are concentrated on the securing portion 21, the solder that supports the securing portion 21 is often detached. Further, the conventional brush 3 provides insufficient elasticity, and thus cannot accommodate deformations in the brush itself caused by the rotation of the rotor 6. Also, the brush 3 has a high center of gravity, and is thus lacking in stability.

### SUMMARY

The present invention aims to provide a brush having enhanced adhesion to the board.

Another object of the invention is to provide a brush having increased elasticity to flexibly manage loads. Another object of the invention is to provide a brush having a low center of gravity for greater stability.

One aspect of the invention provides a brush in contact with a flat commutator for supplying a current, which comprises a plurality of arms in contact with the flat commutator in substantially the same plane, and a support portion, which forms an electrical connection with a current source, for supplying a current to the arms and for securing and supporting the brush. Also, the support portion comprises a through hole of a designated size configured to allow an inflow of solder.

The brush according to an aspect of the invention may additionally include one or more of the following features. For example, the arm may comprise a slit portion, the support portion may comprise a lead portion extending from the arms and a securing portion extending from the lead portion, and the securing portion may have the through hole.

The lead portion may comprise a slot formed in a length direction. The arms may be folded from the lead portion in a perpendicular direction. The lead portion may be folded from the securing portion in a perpendicular direction.

Additional aspects and advantages of the present invention will be set forth in part in the description which follows, and in part will be obvious from the description, or may be learned by practice of the invention.

### BRIEF DESCRIPTION OF THE DRAWINGS

FIG. 1 is a cross-sectional view of a conventional vibration motor.

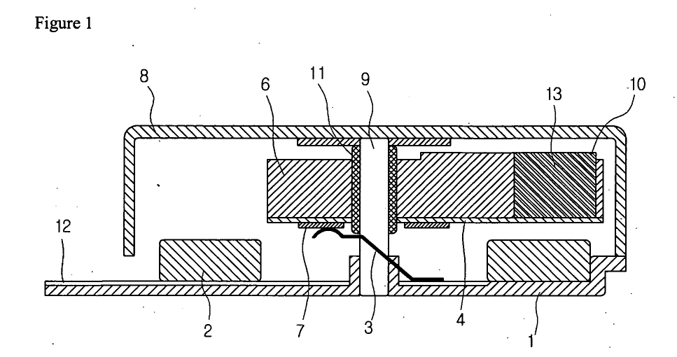

FIG. 2 is a perspective view of brushes used in a conventional vibration motor.

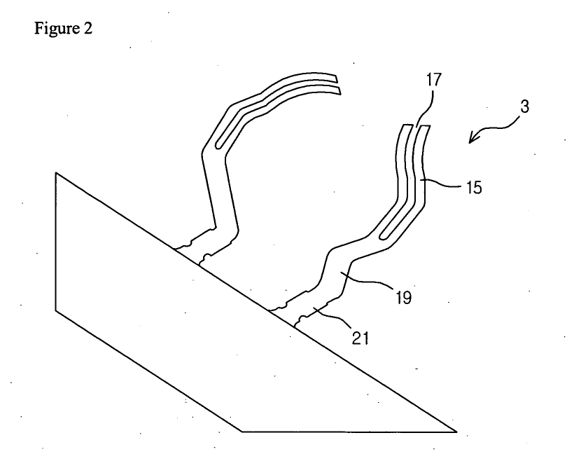

FIG. 3 is a perspective view of brushes according to an embodiment of the invention.

FIG. 4 is a plan view of brushes according to an embodiment of the invention.

FIG. 5 is a side-elevational view of brushes according to an embodiment of the invention.

FIG. 6 is a cross-sectional view illustrating the securing portion and the board secured by solder.

### DETAILED DESCRIPTION

Embodiments of the invention will be described below in more detail with reference to the accompanying drawings.

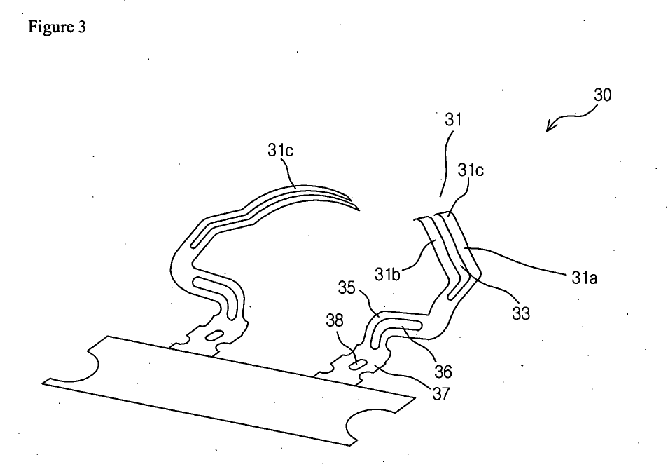

The following will describe a brush according to an embodiment of the invention with reference to FIGS. 3 to 5.

The brush 30 based on an embodiment of the invention comprises arms 31 configured to be in contact with a commutator, a slit portion 33 formed in the arm 31, and a lead portion 35 and securing portion 37 extending from the arm 31. The lead portion 35 and the securing portion 37 form a support portion, which is electrically connected to a current source (not shown), and which supplies electric currents to the arm while securing and supporting the brush. The brush 30 may be formed from a material such as MX215, etc., that has superior electrical and mechanical properties.

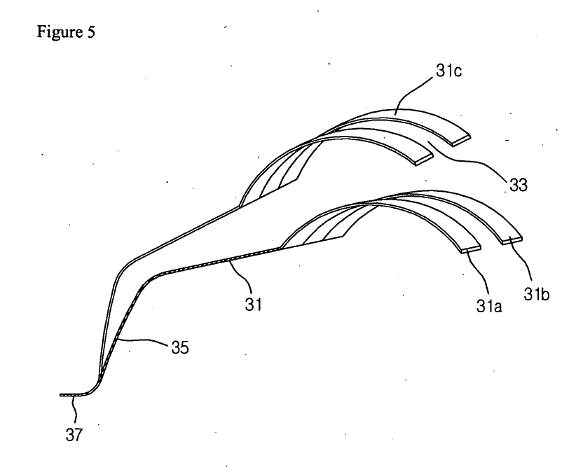

The arm 31 is composed of two segments 31a, 31b separated by the slit portion 33, each of the segments 31a, 31b being identical in shape. The arm 31, as illustrated in FIG. 5, has a contact portion 31 c of which a part is folded in the shape of an arc, where the contact portion 31 c is made to contact the commutator (not shown). The arm 31 is elastically supported by the lead portion 35. Furthermore, the greater the length of the arm 31, the greater the flexibility of the arm, which allows flexible managing of external loads. The segments 31a, 31b are folded in an inward direction in a designated angle.

The slit portion 33 is formed in the arm 31 to separate the arm 31 into segments 31a, 31b. The slit portion 33 provides more independence to the segments 31a, 31b. Thus, the greater the length of the slit portion 33, the more independently may each segment 31a, 31b operate, so that even though one segment is not in contact with the commutator, the other segment is.

In this embodiment, the length of the outer segment 31a is greater. That is, since the arm is folded in the shape of an arc, the length of the outer segment 31a is made greater than the length of the inner segment 31b. Therefore, the elasticity is made different of each segment 31a, 31b, which indicates a difference in contact pressure with respect to the commutator. Thus, in order to equalize the contact pressure between each of the segments 31a, 31b and the commutator, it may be preferable to make the width greater for the outer segment 31a having a greater length.

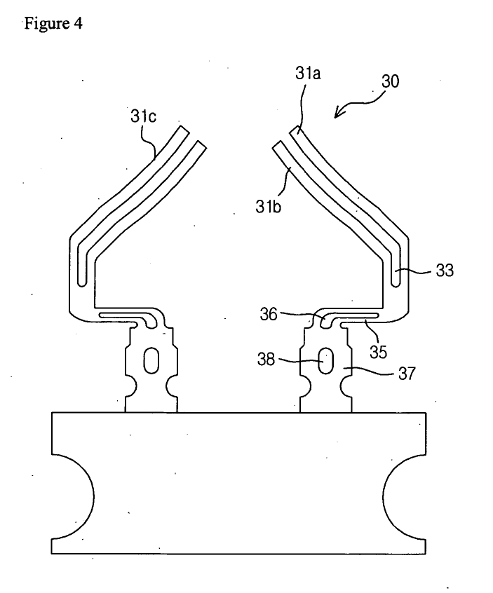

The lead portion 35 connects the arm 31 with the securing portion 37. The lead portion 35 has a slot 36 formed in the length direction, where the slot 36 increases the elasticity of the brush 30 and enables a wider range of responding to deformations caused by external forces. The lead portion 35 and the arm 31, as illustrated in FIGS. 3 and 4, are folded in approximately perpendicular directions, a reason for which is to form a low center of gravity of the brush 30 for increased stability.

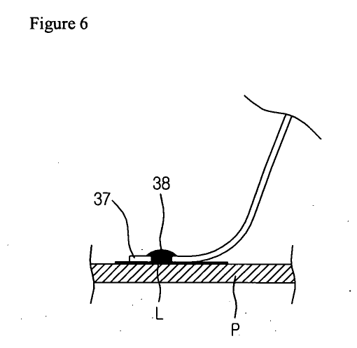

The securing portion 37 extends from the lead portion 35 and is soldered and secured to the board, etc. A through hole 38 is formed in securing portion 37. During the soldering process, there is an inflow of solder through the through hole 38, so that solder is positioned on the securing portion 37, as illustrated in FIG. 6. Thus, since the solder L flowed in through the through hole 38 onto the securing portion 37 holds the securing portion 37 down, the securing portion 37 and the board P are joined more firmly. The lead portion 35 is folded from the securing portion 37 in an almost perpendicular direction, a reason for which is to lower the center of gravity of the brush and ensure stability.

According to the present invention comprised as above, a brush may be provided which has enhanced adhesion for more stability and increased elasticity for the flexible management of loads.

Also, a brush may be provided which has a low center of gravity for greater stability.

What is claimed is:

1. A brush in contact with a flat commutator for supplying a current, the brush comprising:
a plurality of arms in contact with the flat commutator in a substantially same plane; and
a support portion, forming an electrical connection with a current source, for supplying a current to the arms and for securing and supporting the brush,
wherein the support portion comprises a through hole of a designated size configured to allow an inflow of solder.

2. The brush of claim 1, wherein the arm comprises a slit portion,
the support portion comprises a lead portion extending from the arms and a securing portion extending from the lead portion,
and the securing portion comprises the through hole.

3. The brush of claim 2, wherein the lead portion comprises a slot formed in a length direction.

4. The brush of claim 2, wherein the arms are folded from the lead portion in a perpendicular direction.

5. The brush of claim 2, wherein the lead portion is folded from the securing portion in a perpendicular direction.
